(19) United States
(12) Patent Application Publication
(10) Pub. No.: US 2007/0022624 A1
(43) Pub. Date: Feb. 1, 2007

(54) Paint-drying system and method

(75) Inventor: Simon Chu Yuk Man, Taipo (HK)

Correspondence Address: MARSHALL, GERSTEIN & BORUN LLP, 233 S. WACKER DRIVE, SUITE 6300, SEARS TOWER, CHICAGO, IL, 60606, US

(73) Assignee: SINO GOLF MANUFACTURING CO., LTD., New Territories (CN)

(21) Appl. No.: 11/194,225

(22) Filed: Aug. 1, 2005

(51) Int. Cl. F26B 25/00; F26B 3/34

(52) U.S. Cl. 34/270; 34/107

(57) ABSTRACT

A paint-drying system suitable for drying paint applied to a surface of a work piece, the system comprises at least one NIR generating device, at least one holding device for holding one or more work pieces, and a controller for controlling operation of the system. In use, either one or both of the or each NIR generating device and holding device is/are moved relative to the or each other such that the spatial-distance between the or each NIR generating device and a surface of a work piece held by the or each holding device is maintained substantially constant by the controller during actuation of the or each NIR generating device.

The present invention relates to a paint-drying system and method for drying paint applied to a surface of a work piece. In particular, the present invention relates to a paint-drying system and method for drying paint applied to a convex surface, for example, a golf club.

At present, it is common for paint applied to a surface of a work piece, in particular a convex surface, to be dried using a furnace. However, using a furnace has the following disadvantages. The drying time of the paint is long as heat must travel through the outer layers of the paint before reaching the inner layers and layers in contact with the work piece. In particular, this manner of heating relies upon effective heat transfer from air in the furnace to the paint and from subsequent layers of the paint to the work piece. In other words, heating practically only occurs from the outside of the work piece in contact with the hot surroundings to the inside of the work piece. This heating is, of course, affected by the heat transfer coefficient of the paint. Further, the quality of the painted end product work piece after drying depends upon the temperature inside the furnace. The quality is greatly affected by poor performance of most furnaces to provide an even temperature-distribution throughout the inner-space of the furnace. Therefore, such prior art furnaces tend to provide slow drying of paint applied to surfaces of work pieces and the quality of the drying is affected by the inability of most furnaces to provide an even temperature-distribution throughout the entire inner-space. Thus, it is difficult to reproduce a high-quality end product work piece in a timely manner.

Various systems have been proposed in the art which use infrared radiation to provide a constant but localised amount of heat energy. As such, the infrared radiation penetrates some layers of paint causing a heating effect within the paint. Thus, drying of the paint can occur at an external surface of the paint and from within the layers of paint. However, the prior art infrared radiation systems have been found to be only effective for use with planar surfaces. Accordingly, as not all painted surfaces are planar, there is a need for providing a paint-drying system for non-planar surfaces which seeks to minimise the disadvantages of prior art paint-drying system.

Accordingly, in a first aspect the present invention provides a paint-drying system suitable for drying paint applied to a surface of a work piece, the system comprising:

at least one NIR generating device;

at least one holding device for holding one or more work pieces; and

a controller for controlling operation of the system; wherein, in use, either one or both of the or each NIR generating device and holding device is/are moved relative to the or each other and the spatial-distance between the or each NIR generating device and a surface of a work piece held by the or each holding device is maintained substantially constant by the controller during actuation of the or each NIR generating device.

Preferably the or each NIR generating device is stationary and the or each holding device, for holding a work piece, is movable.

Alternatively, the or each holding device, for holding a work piece, is stationary and the or each NIR generating device is movable.

Most preferably, the or each holding device for holding a work piece is rotationally movable. Further, the or each holding device for holding a work piece is a robotic arm. Each robotic arm is capable of multiple-axis (multiple degrees of freedom) movement and can, therefore, easily provide a constant spatial-distance between the or each NIR generating device and a surface of a work piece held by the or each holding device which is reproducible.

The paint-drying system may further comprise one or more work pieces. In use of the paint-drying system, paint applied to a surface of the one or more work pieces is at least partially subjected to NIR or substantially all paint applied to a surface of the one or more work pieces is subjected to NIR.

The one or more work pieces may have a uniform or non-uniform shape.

Preferably, the one or more work pieces have a convex surface. Most preferably, the one or more work pieces are golf clubs.

In a further embodiment the paint-drying system may further comprise an auto feeder or conveyor device for supplying one or more work pieces to the holding device.

In a second aspect, the invention provides a method of drying paint applied to a surface of a work piece, the method comprising: providing at least one NIR generating device; at least one device for holding a work piece; one or more work pieces; and a controller for controlling operation of the or each NIR generating device and holding device, wherein the or each holding device holds one or more work pieces and the one or more work pieces and the or each NIR generating device are brought into proximity and moved relative to the or each other, such that, when the or each NIR generating device is actuated, the spatial-distance between the or each NIR generating device and a surface of the one or more work pieces held by the or each holding device is maintained substantially constant by the controller. The paint applied to the surface of the one or more work pieces is at least partially subjected to NIR.

Alternatively, substantially all paint applied to the surface of the one or more work pieces is subjected to NIR.

During actuation of the or each NIR generating device, the or each NIR generating device is stationary and the or each holding device holding the one or more work pieces is movable.

Alternatively, during actuation of the or each NIR generating device, the or each holding device holding the one or more work pieces is stationary and the or each NIR generating device is movable.

Preferably, the or each holding device provides rotation of the one or more work pieces. Most preferably, the or each device for holding the one or more work pieces is a robotic arm and is, preferably, capable of multiple-axis movement.

Advantageously, the paint-drying system and method of drying paint of the present invention provide a high-quality end product work piece. In addition, the time in achieving such a high-quality end product is greatly reduced. In particular, by keeping the NIR generating device at a constant spatial-distance from a surface of the work piece, substantially all paint to be dried is subjected to a sufficient and constant exposure of NIR. Therefore, the quality of, and speed of achieving, the end product is easily maintained and reproduced. Rotation of the work piece provides a corresponding result over a larger surface area of the work piece.

During the description and claims, the term NIR is used to refer to near-infrared radiation.

Preferred embodiments of the invention will now be described, by way of example only, with reference to the accompanying drawings, in which:

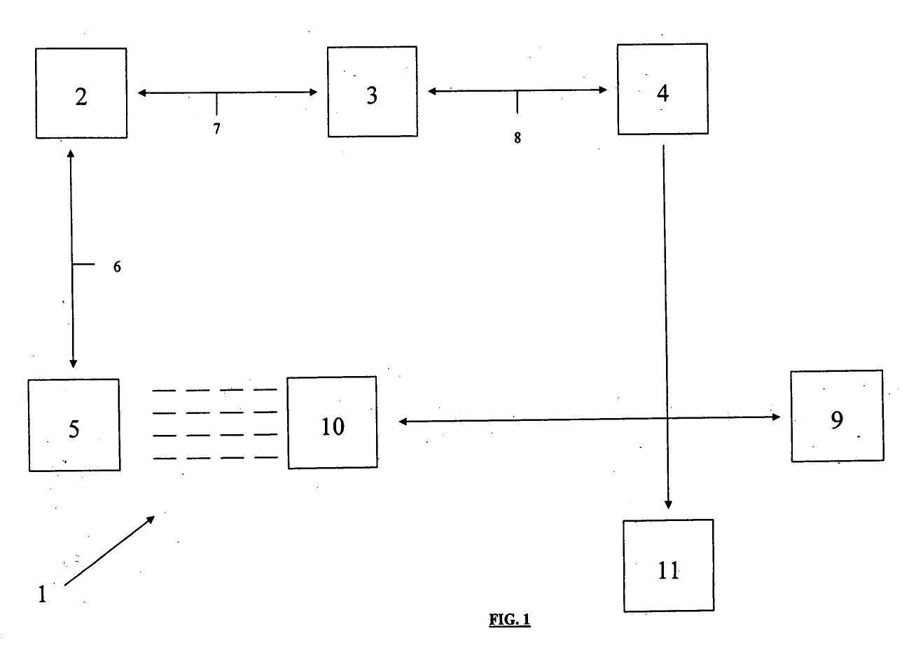

FIG. 1 is a schematic block diagram of the paint-drying system according to the present invention; and

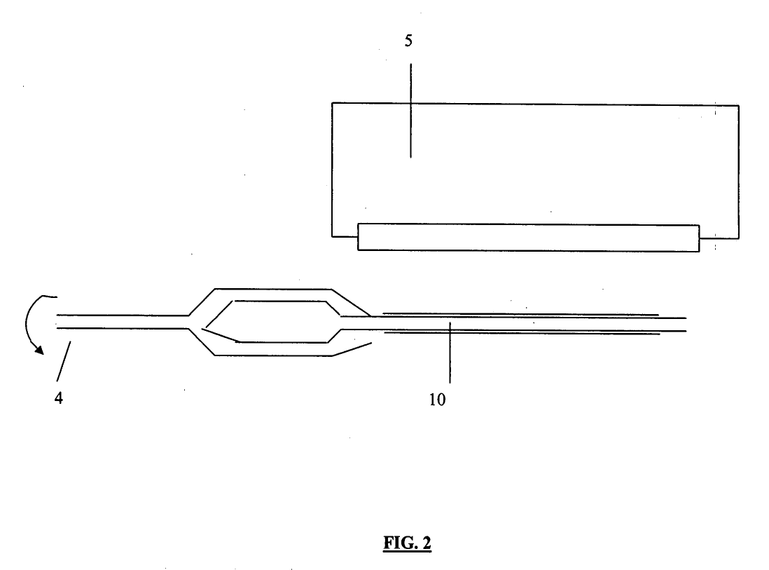

FIG. 2 is a cross-sectional view of part of a golf club held at a constant distance from an NIR generating device during actuation thereof.

FIG. 1 is a schematic block diagram of the paint-drying system according to the present invention. The system has a number of system components and includes a power source 2, a controller module 3, a robotics arm 4 and a NIR (near-infrared radiation) generating device 5. The lines 6, 7 and 8 represent connections between the system components such as power connections, communication connections and/or mechanical connections.

The power source 2 may be any means for supplying electrical power to the controller module 3, the robotics arm 4 and the NIR generating device 5. Additionally, the power source 2 may supply electrical power to other equipment associated with the paint-drying system.

The controller module 3 controls movement of the robotics arm 4 and actuation of the NIR generating device. Accordingly, there are communication connections between the controller module 3 and the robotics arm 4 and the NIR generating device 5. The controller module 3 may be set up to require specific user input for carrying out its tasks of controlling the robotics arm 4 and the NIR generating device. Alternatively, the controller module 3 may be provided with a processor and memory, such that it may run pre-programmed actions and/or user inputted actions. In addition, the processor communicates with the other system components.

The NIR generating device 5 may be any radiation emitting device suitable for generating an infrared radiation having a wavelength in the region of approximately 0.75 to 2.5 micrometers. This region of the electromagnetic radiation spectrum is known as the near-infrared radiation region.

The robotics arm 4 is a standard robotics arm which is capable of multiple-axis (multiple degrees of freedom) movement and which is provided with standard movements of up and down, left and right. In addition, the robotics arm 4 is provided with rotation means for allowing a surface of a work piece 10, held by the robotics arm 4, to be rotated at a constant spatial-distance from the NIR generating device 5 during actuation thereof. In particular, a painted surface of a golf club 10 held by the robotics arm 4 can be rotated at a constant spatial-distance from the NIR generating device 5.

In addition, the system components may be augmented by an auto feeder or conveyor 9 which supplies to the robotics arm 4 a supply of golf clubs 10. The golf clubs 10 are first painted and then conveyed using the auto feeder or conveyor 9 from a painting process to the robotics arm 4 of the paint-drying system 1.

The paint-drying system 1 may also be provided with an end product receptacle 11 where end products having dried paint are temporarily stored prior to further distribution.

In use of the paint-drying system, a golf club fresh from painting thereof is transported from the painting process to the paint-drying system by the auto feeder 9. From the auto feeder 9, the golf club 10 is picked up by the robotics arm 4 and brought into proximity with the NIR generating device 5. The golf club 10 is rotated by the robotics arm 4 and the NIR generating device is actuated to provide NIR—indicated by the dashed lines A—to dry the paint on the golf club 10. Once the paint has been sufficiently exposed to NIR, the NIR generating device 5 is deactivated and the robotics arm 4 transports the golf club 10 to the end product receptacle 11. From there, further distribution of the golf clubs 10 can occur.

During use of the paint-drying system, movement of the robotics arm 4 and actuation of the NIR generating device is controlled by the controller module 3 running pre-programmed actions. In particular, actuation of the NIR generating device may be triggered by the start of rotation of the golf club 10 by the robotics arm 4.

In an alternative embodiment of the invention, one or more of the system components may be provided in a combined form and, thus, provided in a unitary piece of equipment comprising, for example, one or more of the NIR generating device, the robotics arm and the associated controller module and power source. In a further alternative, this unitary piece of equipment may include a conveyor for transporting objects from the painting process.

As shown in FIG. 2, part of a golf club 10—having a layer of un-dried paint 20 thereon—is rotated at a constant distance a from the NIR generating device 5 by the robotics arm 4. Substantially all paint to be dried is subjected to a sufficient and constant exposure of NIR by keeping the NIR generating device at a constant spatial-distance α from a surface of the work piece. Accordingly, the quality of, and speed of achieving, the end product is easily maintained and reproduced.

It will be readily appreciated that a work piece 10 and/or a NIR generator 5 may be moved in any way or path necessary to maintain the constant spatial-distance therebetween and achieve an end product according to the present invention.

Use of the term drying herein may also be taken as meaning curing or setting.

It will also be understood that the invention is not limited in its application to the details of construction and the arrangement of the components set forth above, or as illustrated in the Figures. Also, it is to be understood that the terminology employed herein is for the purpose of description only and is not limiting. The invention may be realised in many different alternatives to that described and illustrated and the true scope and spirit of the invention is as set out in the appended claims.

1. A paint-drying system suitable for drying paint applied to a surface of a work piece, the system comprising:
at least one NIR generating device;
at least one holding device for holding one or more work pieces; and
a controller for controlling operation of the system;
wherein, in use, either one or both of the at least one NIR generating device and the at least one holding device is/are moved relative to the or each other and the spatial-distance between the at least one NIR generating device and a surface of a work piece held by the at least one holding device is maintained substantially constant by the controller during actuation of the at least one NIR generating device.

2. A paint-drying system as claimed in claim 1, wherein, in use of the paint-drying system, the at least one NIR generating device is stationary and the at least one holding device, for holding a work piece, is movable.

3. A paint-drying system is claimed in claim 1, wherein, in use of the paint-drying system, the at least one holding device, for holding a work piece, is stationary and the at least one NIR generating device is movable.

4. A paint-drying system is claimed in claim 2, wherein the at least one holding device for holding a work piece is rotationally and otherwise moveable.

5. A paint-drying system as claimed in claim 1, wherein the at least one holding device for holding a work piece is a robotic arm or is moved by a robotic arm.

6. A paint-drying system as claimed in claim 1, wherein the at least one NIR generating device is moved by a robotic arm.

7. A paint-drying system as claimed in claim 1, wherein the paint-drying system further comprises one or more work pieces.

8. A paint-drying system as claimed in claim 7, wherein, in use of the paint-drying system, paint applied to a surface of the one or more work pieces is at least partially subjected to NIR.

9. A paint-drying system as claimed in claim 7, wherein, in use of the paint-drying system, substantially all paint applied to a surface of the one or more work pieces is subjected to NIR.

10. A paint-drying system as claimed in claim 7, wherein the one or more work pieces have a uniform shape.

11. A paint-drying system as claimed in claim 7, wherein the one or more work pieces have a non-uniform shape.

12. A paint-drying system as claimed in claim 7, wherein the one or more work pieces have a convex surface.

13. A paint-drying system as claimed in claim 7, wherein the one or more work pieces are golf clubs.

14. A paint-drying system as claimed in claim 1, wherein the paint-drying system further comprises an auto feeder or conveyor device for supplying one or more work pieces to the at least one holding device.

15. A paint-drying system as claimed in claim 1, wherein an alternative radiation generating device other than NIR can be used.

16. A paint-drying system suitable for drying paint applied to a surface of a work piece, the system comprising:
at least one radiation generating device;
at least one holding device for holding one or more work pieces; and
a controller for controlling operation of the system;
wherein, in use, either one of the at least one NIR generating device and the at least one holding device is/are moved relative to the other and the spatial-distance between the at least one NIR generating device and a surface of a work piece held by the at least one holding device is maintained substantially constant by the controller during actuation of the at least one radiation generating device.

17. A paint-drying system suitable for drying paint applied to a surface of a work piece, the system comprising:
at least one radiation generating device;
at least one holding device for holding one or more work pieces; and
a controller for controlling operation of the system;
wherein, in use, both of the at least one NIR generating device and the at least one holding device are moved relative to the other and the spatial-distance between the at least one NIR generating device and a surface of a work piece held by the at least one holding device is maintained substantially constant by the controller during actuation of the at least one radiation generating device.

18. A paint-drying system suitable for drying paint applied to a surface of a golf club, the system comprising:
at least one NIR generating device;
at least one holding device for holding one or more golf clubs; and
a controller for controlling operation of the system;
wherein, in use, either one or both of the at least one NIR generating device and the at least one holding device is/are moved relative to the or each other and the spatial-distance between the at least one NIR generating device and a surface of a golf club held by the at least one holding device is maintained substantially constant by the controller during actuation of the at least one NIR generating device.

19. A method of drying paint applied to a surface of a work piece, the method comprising: providing at least one NIR generating device; at least one device for holding a work piece; one or more work pieces; and a controller for controlling operation of the at least one NIR generating device and at least one holding device, wherein the or each holding device holds one or more work pieces and the one or more work pieces and the at least one NIR generating device are brought into proximity and moved relative to the or each other, such that, when the at least one NIR generating device is actuated, the spatial-distance between the at least one NIR generating device and a surface of the one or more work pieces held by the at least one holding device is maintained substantially constant by the controller.

20. A method of drying paint as claimed in claim 19, wherein paint applied to the surface of the one or more work pieces is at least partially subjected to NIR.

21. A method of drying paint as claimed in claim 19, wherein substantially all paint applied to the surface of the one or more work pieces is subjected to NIR.

22. A method of drying paint as claimed in claim 19, wherein, during actuation of the at least one NIR generating device, the at least one NIR generating device is stationary and the at least one holding device holding the one or more work pieces is movable.

23. A method of drying paint is claimed in claim 19, wherein, during actuation of the at least one NIR generating device, the at least one holding device holding the one or more work pieces is stationary and the at least one NIR generating device is movable.

24. A method of drying paint is claimed in claim 23, wherein the at least one holding device provides rotation and/or other movement of the one or more work pieces.

25. A method of drying paint as claimed in claim 19, wherein the at least one device for holding the one or more work pieces is a robotic arm or is moved by a robotic arm.

26. A method of drying paint as claimed in claim 19, wherein the at least one NIR generating device is moved by a robotic arm.

27. A method of drying paint applied to a surface of a golf club, the method comprising: providing at least one NIR generating device; at least one device for holding a golf club; one or more work pieces; and a controller for controlling operation of the at least one NIR generating device and at least one holding device, wherein the or each holding device holds one or more golf clubs and the one or more golf clubs and the at least one NIR generating device are brought into proximity and moved relative to the or each other, such that, when the at least one NIR generating device is actuated, the spatial-distance between the at least one NIR generating device and a surface of the one or more golf clubs held by the at least one holding device is maintained substantially constant by the controller.
